(19) United States
(12) Patent Application Publication
(10) Pub. No.: US 2011/0018860 A1
(43) Pub. Date: Jan. 27, 2011

(54) DISPLAY

(75) Inventors: Lesley Anne Parry-Jones, Oxford (GB); Grant Bourhill, Oxford (GB); Ben John Broughton, Oxford (GB); Jonathan Mather, Oxford (GB); Nathan James Smith, Oxford (GB); Emma Jayne Walton, Oxford (GB); Michel Sagardoyburu, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(73) Assignee: SHARP KABUSHIKI KAISHA, Osaka (JP)

(21) Appl. No.: 12/867,079

(22) PCT Filed: Feb. 20, 2009
(86) PCT No.: PCT/JP2009/053619

§ 371 Date: Sep. 2, 2010

(30) Foreign Application Priority Data
Feb. 21, 2008 (GB) 0803174.2

(51) Int. Cl. G09G 5/00

(52) U.S. Cl. 345/214

(57) ABSTRACT

A display is provided having private and public viewing modes. The display comprises a display device and a parallax optic (3) comprising an array of parallax elements (4). Each of the elements (4) co-operates with a set of pixels (1,2) having at least one first pixel (1) and at least one second pixel (2). A line (23) passing through the centre (21) of each first pixel (1) and the centre (22) of the cooperating parallax element (4) extends into a first viewing region (20a). The parallax elements (4) re-strict viewing of the first pixels (1) to the first viewing region and permit viewing of the second pixels (2) in a second viewing region. The display device displays a private image in the private viewing mode by means of only the first pixels (1) and displays a non-private image in the public viewing mode by means of at least the second pixels (2).

### TECHNICAL FIELD

The present invention relates to a display having private and public modes of operation. In the first ‘public’ mode, such a display may have a wide viewing angle for general use. In the second ‘private’ mode, such a display may have a narrow viewing angle for the main image which is viewed by the legitimate user. At wider viewing angles, a secondary image may be displayed or the display may appear blank, preventing off-axis viewers from viewing the private information.

Such a display may be used in many applications where a user may wish to view confidential information, but cannot control who else may be watching. Examples are mobile phones, Personal Digital Assistants (PDAs), laptop computers, desktop monitors, Automatic Teller Machines (ATMs) and Electronic Point of Sale (EPOS) equipment. Such a display may also be used in situations where it is distracting and therefore unsafe for certain viewers (for example drivers or those operating heavy machinery) to be able to see certain images, for example, road-side advertising or an in car television screen.

### BACKGROUND ART

Electronic display devices, such as monitors used with computers and screens built in to telephones and portable information devices, are usually designed to have a viewing angle as wide as possible, so that they can be read from any viewing position. However, there are some situations where a display which is visible from only a narrow range of angles is useful. For example, one might wish to read a private document using a portable computer while on a crowded train.

A number of devices are known which restrict the range of angles or positions from which a display can be viewed.

### Non-Switchable Privacy Displays

U.S. Pat. No. 6,552,850 (E Dudasik; Citicorp Inc. 2003) describes a method for the display of private information on a cash dispensing machine. Light emitted by the machine's display has a fixed polarisation state, and the machine and its user are surrounded by a large screen of sheet polariser which absorbs light of that polarisation state but transmits the orthogonal state. Passers by can see the user and the machine but cannot see information displayed on the screen.

A versatile method for controlling the direction of light is a ‘louvred’ film which consists of alternating transparent and opaque layers in an arrangement similar to a Venetian blind. Like a Venetian blind, it allows light to pass through it when the light is travelling in a direction parallel or nearly parallel to the layers, but absorbs light travelling at large angles to the plane of the layers. These layers may be perpendicular to the surface of the film or at some other angle. Methods for the production of such films are described in a series of patents filed by the 3M corporation: U.S. RE27617 (F O Olsen; 3M 1973), U.S. Pat. No. 4,766,023 (S L Lu; 3M 1988) and U.S. Pat. No. 4,764,410 (R F Grzywinski; 3M 1988).

Other methods exist for making films with similar properties to the louvred film. These are described, for example, in U.S. Pat. No. 5,147,716 (P A Bellus; 3M 1992) and U.S. Pat. No. 5,528,319 (R R Austin; Photran Corp. 1996). U.S. Pat. No. 6,239,911 (T Koike; Kimoto Co. Ltd. 1997) describes a viewing angle control sheet which consists of a light permeable polymer layer which contains cracks which are regular in direction. The sheet transmits light which travels in a direction parallel to the cracks, but blocks rays travelling in other directions. The action of this light control film is very similar to the louvre with less unwanted light absorption.

Most display methods are wasteful of power because they emit light in all directions, whereas light often need only be emitted towards a single, or small number, of users. With this in mind, there are patents which exist that describe the use of lenses to steer the emitted light either in a particular direction or into a single plane, either for the purpose of power saving or for brightness enhancement. For example, U.S. Pat. No. 6,570,324 (L Tutt; Eastman Kodak Company 2003) describes a way of directing light from an Organic Light Emitting Diode (OLED) display towards a single user, by positioning small OLED pixels beneath a 2D array of spherical micro-lenses. Because the area of OLED material to be addressed is so much lower, the power consumption is drastically reduced for the same output brightness to the user. The display can now only be viewed from a single position, and hence this arrangement also leads to privacy. GB2405542 describes the use of lenses as a way of directing light primarily for use in dual view displays, although privacy displays are mentioned. This last patent does not describe how electronically switchable privacy can be achieved, nor how the pixel sizes can be optimised in order to maintain on-axis resolution in the public mode. Other relevant prior art in the area of non-switchable privacy using lenses to direct light comprises:

1. JP2002299039 (N Furumiya, Sanyo Electric Co Ltd, 2002)

2. JP2006236655 (K Furukawa, Konica Minolta Holdings Inc, 2006)

3. U.S. Pat. No. 6,809,470 (R M Morley; Intel Corporation 2000)

4. U.S. Pat. No. 7,091,652 (R M Morley; Intel Corporation 2004)

5. U.S. Pat. No. 6,935,914 (A Ito; Mitsubishi 2001)

6. WO0133598 (J C Strurm; Princeton University 2000)

7. WO03007663 (S Möller; Princeton University 2002)

### Switchable Privacy Displays

Although all of the technologies described above can be used in order to create a privacy display, in none of these cases is the privacy switchable so that the display can be turned into one that is visible to a wide range of users.

US patent application 2002/0158967 (J M Janick; IBM, published 2002) shows how a light control film can be mounted on a display in such a way that it can be moved over the front of the display to give a private mode, or mechanically retracted into a holder behind or beside the display to give a public mode. This method has the disadvantages that it contains moving parts which may fail or be damaged and that it adds considerable bulk to the display.

There is a variety of ways in which displays can be made which are electronically switchable. For example, a light control film such as described in the previous section can be followed by a switchable diffuser (normally a polymer-dispersed liquid crystal cell), as described in the following patents:

1. U.S. Pat. No. 831,698 (S W Depp; IBM 1998)

2. U.S. Pat. No. 6,211,930 (W Sautter; NCR Corp. 2001)

3. U.S. Pat. No. 5,877,829 (M Okamoto; Sharp KK 2001)

Alternatively, a switchable louvre system is possible using dyed or un-dyed liquid crystal (LC) elements in the louvre:

1. U.S. Pat. No. 5,825,436 (K R Knight; NCR Corp. 1998)

2. GB2405544 (A Evans; Sharp K K 2003)

A further alternative is to use an extra LC cell on top of the display to electrically alter the viewing angle characteristics of the display:

1. GB2413394 (Winlow)

2. GB2421346 (Evans)

3. GB2418518 (Bonnett)

4. WO04070451 (G J Woodgate; Ocuity Ltd. 2004)

All of the electrically switchable techniques described above involve adding extra thickness and weight to the existing display panel, and hence are less desirable for use with screens in portable devices which are ever decreasing in size and thickness. A number of technologies exist which describe ways of creating switchable privacy by using the natural viewing angle dependence of liquid crystal displays:

1. JP09230377 and U.S. Pat. No. 5,844,640 (Sharp, 1996)

2. US20070040975A1 (LG Philips, 2005) and SID '07 Digest pp 756-759

3. US20070121047A1 (LG Philips, 2005) and SID'06 digest pp 729-731

4. US20060109224 (Au Optronics, 2005)

5. US20040207594 (Sharp, 2003) and GB2428152A1 (Sharp, 2005)

6. Rocket Software, Inc. (http://www.rocketsoftware.com)

7. JP 1999-11-30783 (Mitsubishi, 1999)

8. U.S. Pat. No. 6,646,707 (BOE Hydis, 2001)

9. JP 1999-11-30783 and US20060267905A1 (Casio, 2005)

10. US20070046881 (Casio, 2005)

11. GB2428101 (Gass)

12. British Patent Application No. 0721.255.8 (Broughton)

Although all of these methods are advantageous in terms of adding no extra thickness to the existing display panel, they are specific to the use of a liquid crystal display (LCD) mode, and could not (for example) be used to make a switchable privacy OLED display.

There is clearly a need for a privacy technology which adds little or no extra thickness to an existing display panel and can also be applied to all types of display mode, including Cathode Ray Tube (CRT), LCD, Plasma Display Panel (PDP), OLED, Field Emission Display (FED), Surface-conduction Electron-emitter Display (SED) etc.

### DISCLOSURE OF THE INVENTION

According to a first aspect of the invention, there is provided a display having private and public viewing modes, comprising a display device and a parallax optic, the parallax optic comprising an array of parallax elements, each of which cooperates with a respective set of pixels of the display device comprising at least one first pixel, which is aligned with the parallax element such that straight a line passing through a centre of the at least one first pixel and through a centre of the parallax element extends into a first viewing region, and at least one second pixel such that the parallax elements restrict viewing of the first pixels to the first viewing region and permit viewing of the second pixels in a second viewing region, the display device being arranged to display a private image in the private mode by means of only the first pixels and to display a first non-private image in the public mode by means of at least the second pixels.

At least one of the sets of pixels may be disposed at or adjacent the middle of a surface of the display device in which the pixels are disposed and the straight line may intersect the surface substantially perpendicularly. The surface may be substantially planar.

Each parallax element may be a one-dimensional parallax element having a centre line, the at least one first pixel may comprise a line of first pixels having a centre line which is aligned with the centre line of the parallax element such that at least part of a plane containing the centre lines of the parallax element and the line of first pixels extends into the first viewing region, and the at least one second pixel may comprise first and second lines of second pixels, parallel to and on opposite sides of the line of first pixels. In each pair of adjacent sets, the first line of second pixels of one of the sets may comprise the second line of second pixels of the other of the sets and may be aligned with a further centre line midway between the centre lines of the associated parallax elements.

The display device may be arranged to display a second non-private image in the private mode by means of the second pixels. The second non-private image may be the same as the first non-private image.

The display device may be arranged to display the first non-private image in the public mode by means of the first and second pixels. The first and second viewing regions may partially overlap and the first and second pixels may be arranged, in the public mode, to display different image pixels of the first non-private image.

The second viewing region may comprise a plurality of sub-regions. The sub-regions may be substantially non-overlapping. The first viewing region may be disposed between the first and second ones of the sub-regions.

The array may be a regular array.

The parallax optic may comprise a lens array and each parallax element may comprise a lens of the array.

The parallax optic may comprises a parallax barrier and each parallax element may comprise an aperture. The parallax optic may comprise a respective lens at each aperture of the barrier.

According to a second aspect of the invention, there is provided a display having private and public viewing modes, comprising a display device and a parallax optic, the parallax optic comprising an array of lenses separated from each other by opaque regions, each of the lenses cooperating with a respective set of pixels of the display device comprising at least one first pixel and at least one second pixel such that the lenses restrict viewing of the first pixels to a first viewing region and permit viewing of the second pixels in a second viewing region, the display device being arranged to display a private image in the private mode by means of only the first pixels and to display a first non-private image in the public mode by means of at least the second pixels.

The parallax elements may have a pitch which differs from a pitch of the sets of pixels so as to provide view point correction.

The first pixels may be of a different size from the second pixels.

According to a third aspect of the invention, there is provided a display having private and public viewing modes, comprising a display device and a parallax optic, the parallax optic comprising an array of parallax elements, each of which cooperates with a respective set of pixels of the display device comprising at least one first pixel and at least one second pixel such that the parallax elements restrict viewing of the first pixels to a first viewing region and permit viewing of the second pixels in a second viewing region, the first pixels being of a different size from the second pixels, the display device being arranged to display a private image in the private mode by means of only the first pixels and to display a first non-private image in the publc mode by means of at least the second pixels.

Each of the first pixels may be smaller than each of the second pixels. Each of the first pixels may be narrower than each of the second pixels.

Each of the sets may comprise at least one further pixel.

The display device may be arranged to modulate light passing therethrough. The display device may be a liquid crystal device.

The display device may be a light-emissive device. The display device maybe an emitting diode device comprising a plurality of pixel-defining electrodes facing first and second patterned electrodes defining the first and second pixels, respectively.

The parallax optic may be disposed between the display device and the first and second viewing regions.

The display may be at least partially transmissive and may be disposed between the parallax optic and the first and second viewing regions.

It is thus possible to provide a display with electrically switchable viewing angle. This switchability may be obtained by subdividing each pixel into a plurality of sub-pixels, each of which emits light into a different range of viewing angles. The directivity of the emitted light may be achieved through the use of microlenses, a parallax barrier, or a combination of the two. “Private” or “public” viewing modes may be obtained by controlling the sub-pixels independently. In the “private” mode, the off-axis view may either be blank, or an alternative, controllable side-image of substantially equal luminance. An advantage of this type of display is that it may be applied to any type of display mode, and hence is equally applicable to backlit transmissive (e.g. LCD), emissive (e.g. PDP, OLED) or reflective (e.g. electrophoretic, LCD) display modes. Another advantage is that the technology can be designed so that it adds little or no extra thickness to the overall display panel. This is a very important as display modules for portable devices become ever thinner. A further advantage is that, by designing the parallax optics appropriately, privacy in both the horizontal and vertical directions may be achieved. Finally, the display may be designed either to achieve full pixel resolution on-axis in public mode, or to display a secondary side image (which could be used, for example, to display advertisements).

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 illustrates a display constituting an embodiment of the invention and the light intensity that will be observed by a viewer at different viewing angles;

FIG. 2 illustrates a number of alternatives for applying the lens and barrier arrangement (3+4) to the display;

FIG. 3 illustrates a display constituting another embodiment of the invention and its light intensity against viewing angle;

FIG. 4 illustrates a display constituting further embodiment of the invention and its light intensity against viewing angle;

FIG. 5 illustrates the need for “view-point correction” in a display that is observed by a viewer at a finite distance from the display;

FIG. 6 illustrates a display constituting a further embodiment of the invention and its light intensity against viewing angle;

FIG. 7 illustrates a modified pixel layout (a) and staggered lens and barrier arrangement (b) that are used in a further embodiment of the invention;

FIG. 8 illustrates a variation on the staggered pixel embodiment in which the lenses are striped rather than staggered;

FIG. 9 illustrates an embodiment where there is no barrier between the lenses;

FIG. 10 illustrates an embodiment where there are no lenses covering the barrier slits;

FIG. 11 illustrates an example of a pixel layout (a) and lens and barrier arrangement (b) that would be suitable for an embodiment that provides privacy in two dimensions;

FIG. 12 illustrates a further example of a pixel layout (a) and lens and barrier arrangement (b) that would be suitable for an embodiment that provides privacy in two dimensions;

FIG. 13 illustrates an embodiment of the invention in which the type of display used is a transmissive LCD with conventional polarisers;

FIG. 14 illustrates a variation of the display of FIG. 13 in which the polarisers are both positioned on one side of the lens and barrier arrangement;

FIG. 15 illustrates a variation in which in-cell polarisers (and optional in-cell retarders) are used instead of conventional ones;

FIG. 16 illustrates a further embodiment in which the lens and barrier arrangement is between the backlight and the LCD instead of between the LCD and the viewer;

FIG. 17 illustrates a further embodiment of the invention in which a reflective LCD is used in which the reflective element is placed underneath the display;

FIG. 18 illustrates a further embodiment of the invention in which a transflective LCD is used which uses pixels which have both reflective and transmissive portions;

FIG. 19 illustrates a variation in which the reflective element is placed between the LC layer and the ITO electrodes;

FIG. 20 illustrates a further embodiment in which any other kind of reflective technology is used for the display, for example, an electrophoretic display; and

FIG. 21 illustrates a method of hybrid addressing applicable to LED or OLED displays.

### BEST MODE FOR CARRYING OUT THE INVENTION

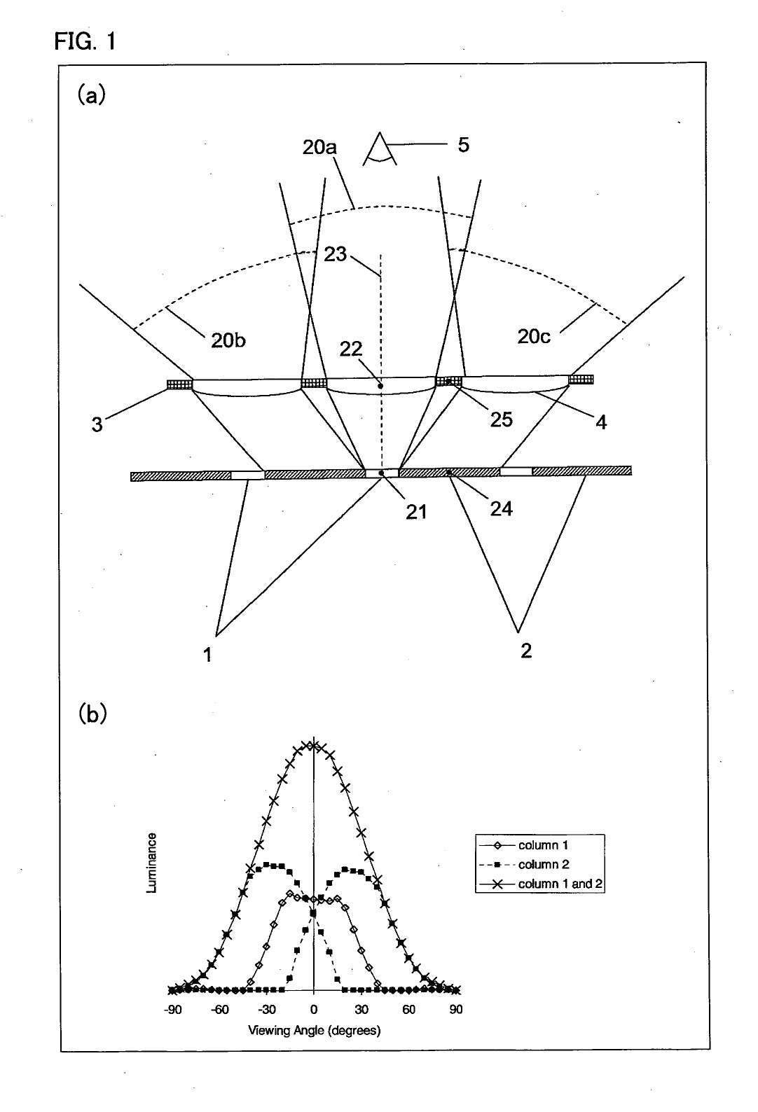

Portions (a) and (b) of FIG. 1 show a display panel comprising a rectangular array of pixels which are subdivided into two types, namely first pixels 1 and second pixels 2. These two types form alternating lines or columns which may be of different widths. Portion (a) of FIG. 1 shows the case where pixel column 1 is narrower than pixel column 2, but this embodiment is not limited to that case. Situated between the pixels and the viewer (5) is a parallax optic in the form of a barrier layer which comprises a regular array of parallax elements in the form of apertures or slits separated by a series of parallel stripes (3), whose pitch is equal to that of a pair of pixel columns 1 and 2. The stripes are made from a light-absorbing material, such as black photoresist that is used for masking off thin film transistors (TFTs) in an LCD. In the slits between the barrier stripes are formed a series of cylindrical lenses (4), whose width may or may not completely cover the gap between the barrier stripes.

The registration of the barrier layer with respect to the image forming layer is such that the barrier stripes are parallel to the pixel columns, and the centre of the barrier is positioned at the centre of pixel column 2. Therefore, the centre of the slits between the barrier stripes is aligned with the centre of pixel column 1. In particular, the centre 21 of each of the first pixels 1 is aligned with the centre 22 of the cooperating parallax element 4 such that a straight line 23 passing through the centres 21 and 22 extends into a first viewing region 20a. In the embodiment shown in FIG. 1a where the lenses 4 are elongate and cyndrically converging to provide one-dimensional parallax and where the first pixels 1 of each set are arranged as a column, 21 and 22 represent centre lines of the pixel column and the parallax element and 23 represents a plane containing the centre lines with at least part of the plane 23 extending into the first viewing region 20a. Similarly, a centre line 24 of each column of the second pixels 2, which is parallel to the column of first pixels 1, is aligned parallel to the plane 23, with a further centre line 25 which is midway between adjacent centre lines 22.

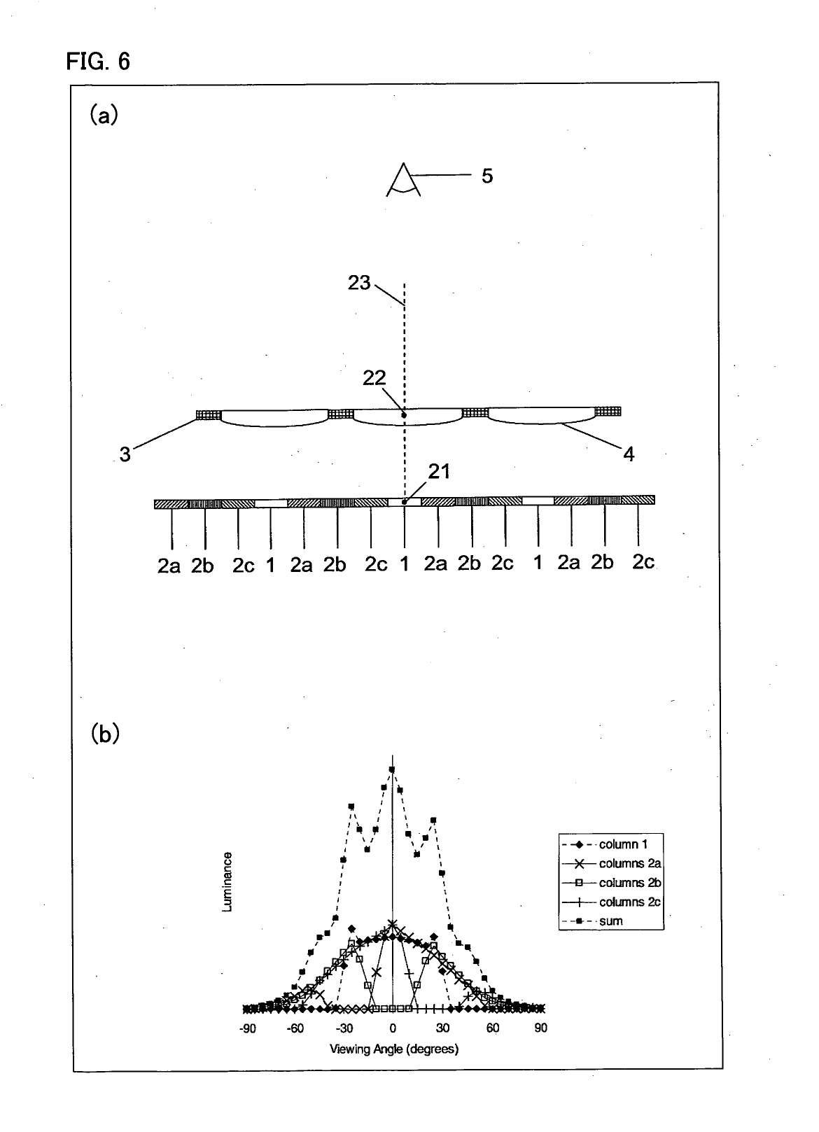

Each lens 4 cooperates with a respective set of pixels which, in this embodiment, comprises the adjacent column of first pixels 1 and the adjacent first and second columns of second pixels 2 on opposite sides of the first pixel column this case, for adjacent sets of pixels, the first column of second pixels 2 of one set forms the second column of second pixels 2 of the adjacent set. In other embodiments, for example as illustrated in FIG. 6a and described hereinafter, each set of pixels may comprise further pixels, for example arranged as one or more further columns disposed on opposite sides of the columns of second pixels 2 from the column of first pixels 1.

In the embodiment shown in FIG. 1a, the pixels 1 and 2 are disposed in a plane surface and the line 23 intersects this surface substantially perpendicularly. However, for displays which include viewpoint correction as described hereinafter and intended to be viewed normal to the middle of the display, this applies to pixels which are at or adjacent the middle of the display.

As shown in Portion (b) of FIG. 1, when pixel column 1 is illuminated, and pixel column 2 is not, the resulting light emitted from the display is visible to a viewer only at or close to normal incidence in the first viewing region 20a; hence this data is “private”. When pixel column 2 is illuminated and pixel column 1 is not, however, the resulting emitted light is visible in sub-regions 20b and 20c of a second viewing region to viewers both at normal incidence and at oblique incidence to the display, hence this data is “public”. The first viewing region 20 is disposed between the first and second ones of the sub-regions 20b and 20c in this embodiment. When both pixel columns 1 and 2 are illuminated, both sets of pixels are visible close to normal incidence, and hence full resolution is available to an on-axis observer in “public mode”.

An example of a pixel layout and lens and barrier design that gives viewing windows as illustrated in Portion (b) of FIG. 1 is as follows. Pixels of type 1 have a width of 40 μm, and pixels of type 2 have a width of 12.0 μm. The lenses (4) have a radius of curvature of 80 μm, a refractive index of 1.52 and the width in the plane of the barrier (3) is 130 μm. The width of the barrier is 30 μm. The separation of the lens and barrier arrangement (3+4) from the pixels is a total of 110 μm, of which 50 μm is glass directly above the pixels, and 60 μm is a glue layer of refractive index 1.37 which is between the lenses and the glass. These dimensions are an example of a suitable design for this type of display but the display is not limited to this case.

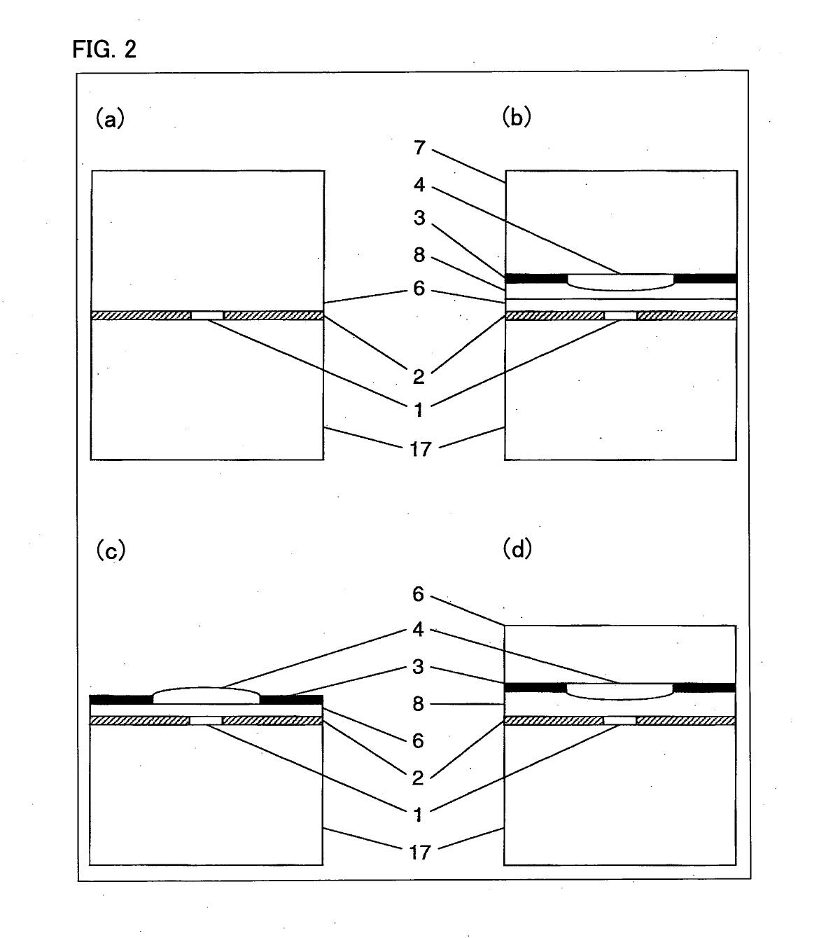

The dimensions of the pixels, and the desired angular separation between the viewing windows require a separation between the pixel plane (1+2) and the lens and barrier plane (3+4) that is generally much smaller than a typical display top glass substrate (6) (Portion (a) of FIG. 2). In this case, it will therefore be necessary to significantly thin the top glass substrate before adhering the lens and barrier substrate (7) to the top of the display. This arrangement is shown in Portion (b) of FIG. 2, where the planarising gap (8) between the top substrate of the display (6) and the lens and barrier substrate (7) can either be an air gap or a layer of glue. The overall ruggedness of the display will not be affected because the thickness of the substrate on which the lens and barrier arrangement is formed will generally be greater than or equal to the thickness of glass that has been removed from the original display top glass substrate. In the case where it is equal (as shown in FIG. 2) then it is clear that the thickness of the overall display is now substantially the same as for a conventional display.

Alternatively, the lens and barrier array (3+4) may not be formed on a separate substrate (7), but instead may be formed directly onto the top substrate of the display (6), as shown in Portion (c) of FIG. 2. A further alternative is that the lens and barrier array (3+4) is formed between the pixel elements (1 and 2) and the top substrate of the display (6). As Portion (d) of FIG. 2 shows, the pixel elements are separated from the lens and barrier array (3+4) by a planarising layer (8).

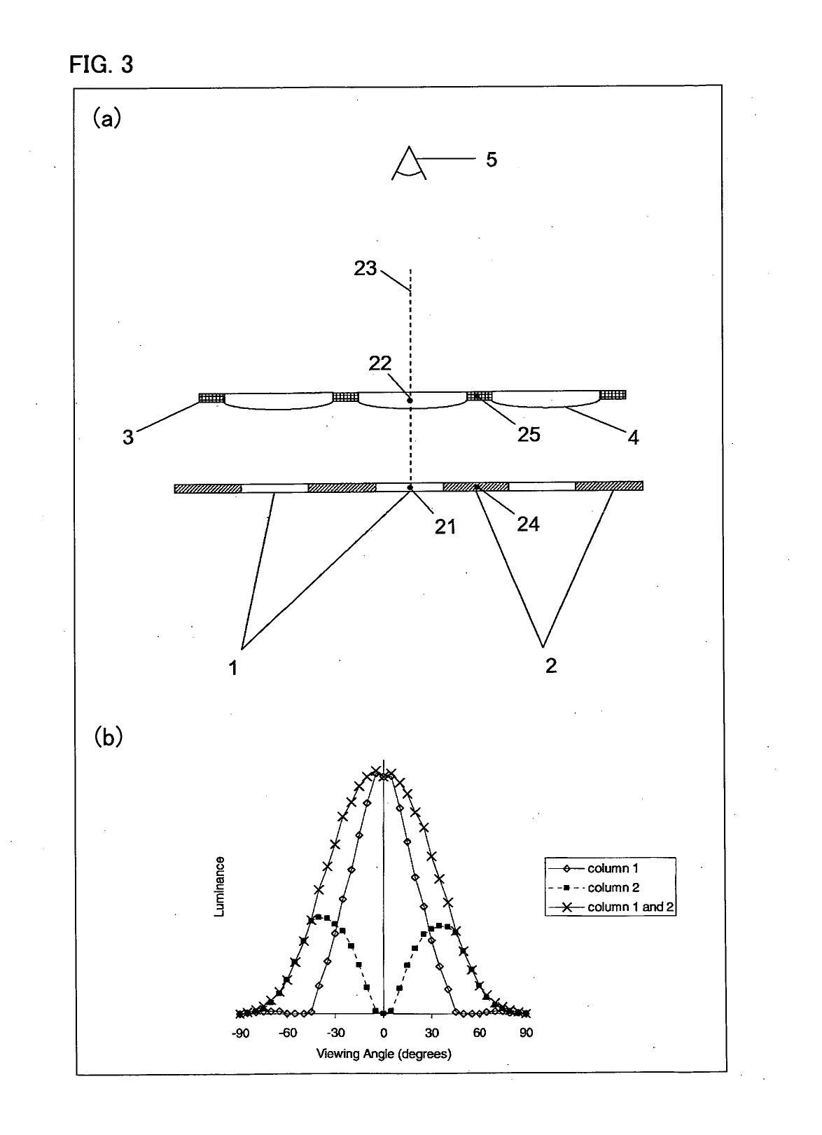

In a second embodiment of the invention, the relative widths of pixel columns 1 and 2, and/or the lens and barrier design are different from the previous embodiment, as shown in Portion (a) of FIG. 3. Now when pixel column 2 is illuminated and pixel column 1 is not, the resulting emitted light is not visible at normal incidence, but only at oblique incidence, as Portion (b) of FIG. 3 shows. Therefore, when both pixel columns 1 and 2 are illuminated, to display a first “non-private” or public image, only pixel set 1 is visible close to normal incidence, and hence only half resolution is perceived in “public mode”. However, because of the lack of overlap between the light emitted from pixel sets 1 and 2, it is now possible to display a secondary image (or second non-private image) using pixel set 2, when pixel set 1 is providing a primary “private” image to a viewer close to normal incidence. This secondary image can be completely unrelated to the primary image, may be the same as the first non-private image, and could be used, for example, to display advertising.

In a third embodiment of the invention, the widths of pixel columns 1 and 2 are equal to each other, so that the pixel layout is essentially unaltered from an ordinary display with no privacy function. With this pixel layout, it is possible to obtain either of the two desirable features of the previous two embodiments, i.e. full resolution at normal incidence (embodiment 1) or a separate side image (embodiment 2). However, in order to achieve this with a display with equal pixel sizes, it is necessary to do so either at the cost of privacy or brightness. Such a lower cost solution may be desirable for some applications.

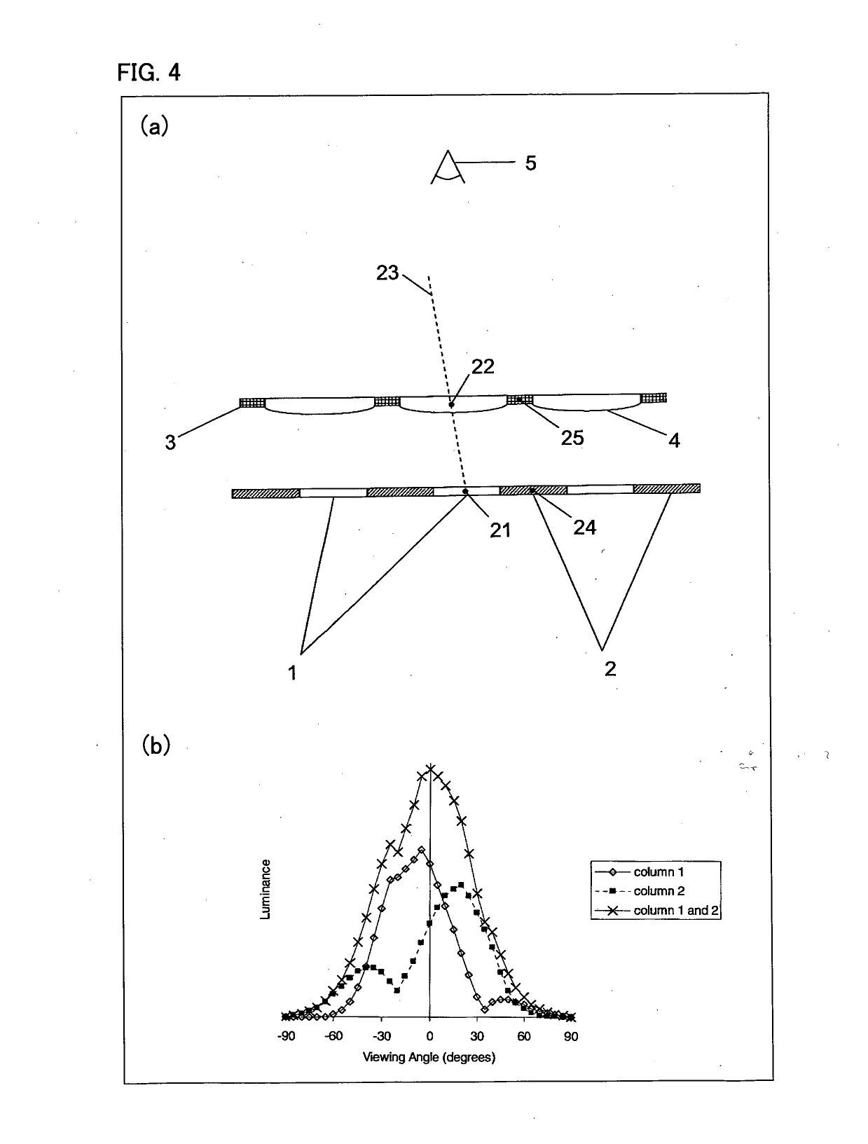

In a fourth embodiment of the invention, the registration of the barrier layer with respect to the image forming layer is not as in the previous embodiments. The barrier stripes still remain parallel to the pixel columns. However, the centres of the barrier stripes are no longer aligned with pixel columns 2 but are slightly offset, as shown in Portion (a) of FIG. 4. This has the effect of shifting the viewing angles from which the two pixel sets are visible as shown in Portion (b) of FIG. 4. In particular, pixel set 1 will now no longer be best viewed at normal incidence, but at some angle which is determined by the amount of offset of the barrier relative to the pixels. This feature may be useful for designing a privacy display for a particular application, for example, a DVD player in the centre console of a car, whose image should be visible to the passengers in the car but invisible to the driver.

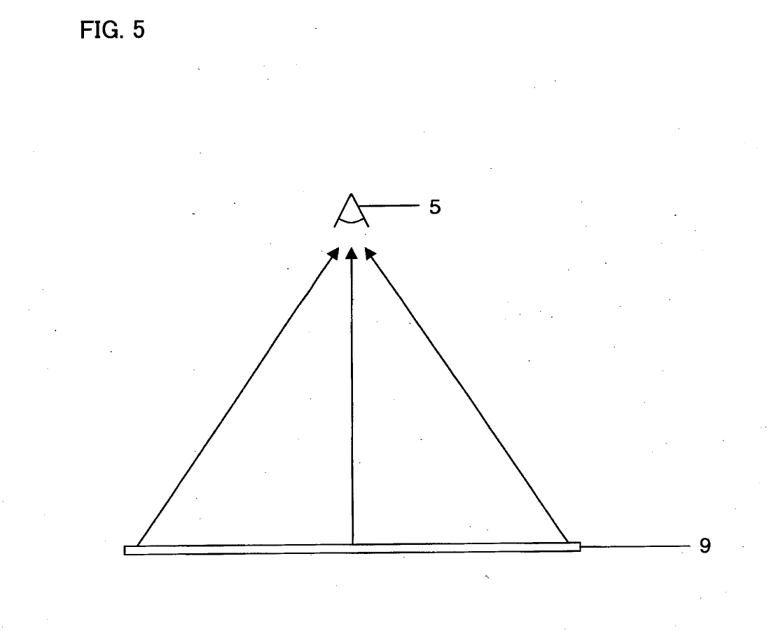

In a fifth embodiment of the invention, the pitch of the barrier layer is very slightly less than the combined pitch of the pixel columns 1 and 2, instead of being equal as in the previous embodiments. This is known as “view point correction” and takes into account the fact that the viewer (5) sees the screen (9) from a finite viewing distance, and hence the light entering the viewer's eye from different points on the same screen is different (see FIG. 5). In order for the privacy function of the display to work correctly at all points on the screen, and not just in the centre, the barrier must be offset relative to the pixel layout (as in the previous embodiment) by different amounts at different points in the screen. This variable offset changes continuously across the screen, and therefore results in a slightly smaller barrier pitch compared to the pixel column pitch (1+2).

In the previous embodiments of the invention, there are two columns of pixels (1 and 2) for every pitch of the lens plus barrier arrangement. In a sixth embodiment of the invention, which can apply to all of the above embodiments, there are more than two columns of pixels for every single barrier pitch. This allows the possibility of showing more than two images at once. For example, Portion (a) of FIG. 6 shows the case where there are four columns of pixels such that each set comprises pixels: 1, 2a, 2b and 2c, in which case the display can be operated in many modes. If all four columns of pixels display the same image, then that image is visible from all viewing angles (“public mode”). However, if pixel column 2b is switched off, then the image can only be viewed from a limited range of angles creating a privacy effect. Further, if pixel columns 2a and 2c are also switched off, the range of viewing angles is further restricted giving a very strong privacy effect. In another mode, pixel columns 1 and 2b are switched off, and pixel columns 2a and 2c are switched on but show different images: this can result in either a dual view display or an auto-stereoscopic display, depending on the viewing distance and the type of images used. Viewing angles for different modes of operation are shown in Portion (b) of FIG. 6.

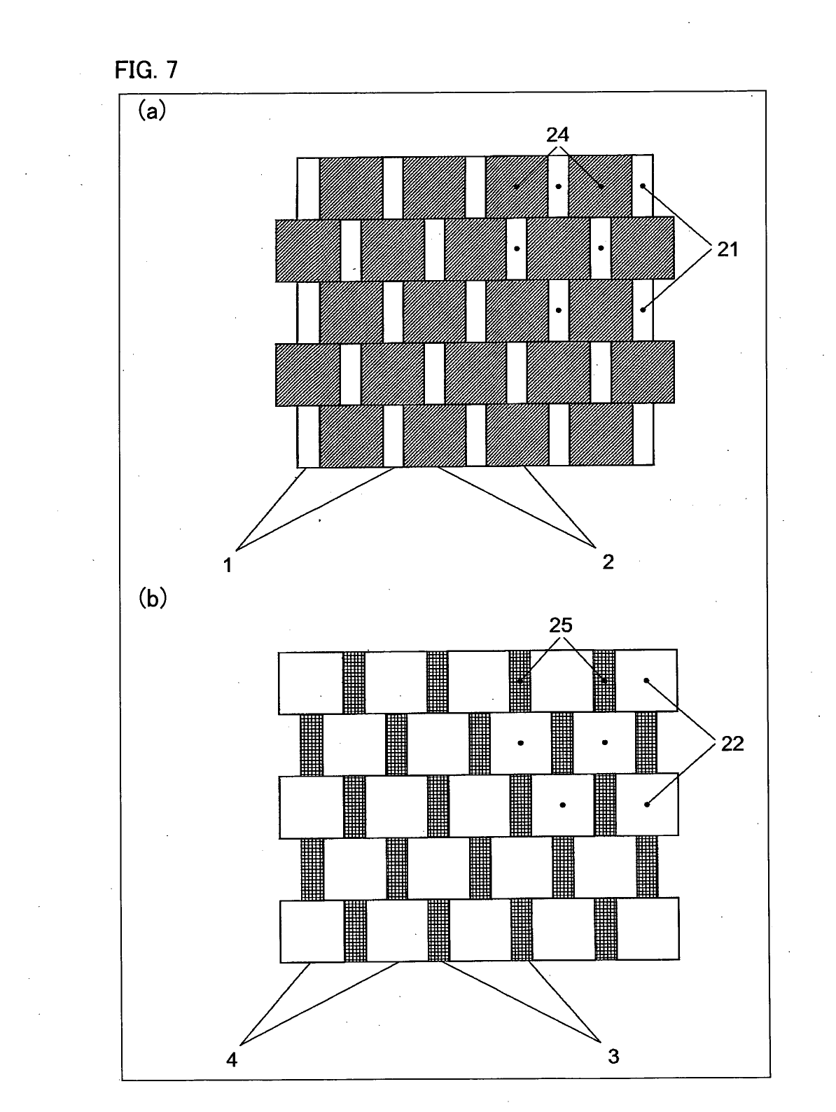

In a seventh embodiment of the invention, the pixel layout is modified with respect to that in the previous embodiments. Portion (a) of FIG. 7 shows a view of the modified pixel layout from above. There are still two sets of pixels 1 and 2 of differing width but, instead of being arranged in columns as in the previous embodiments, the registration of pixels 1 and 2 from row to row is changed so that the pixels are “staggered”. Correspondingly, the barrier design is modified so that the same rule applies as in the first embodiment, i.e. the centre of the barrier coincides with the centre of pixel 2, and the centre of the lens coincides with the centre of pixel 1. The result is shown in FIG. 7b, and is often termed a “chequerboard” barrier, although since the lens and barrier widths can be unequal, the checks are not necessarily square. The advantage of the chequerboard design is that, for a given barrier pitch and stripe width, the visibility of the barrier to the user is reduced significantly by using a chequerboard barrier compared with a striped barrier.

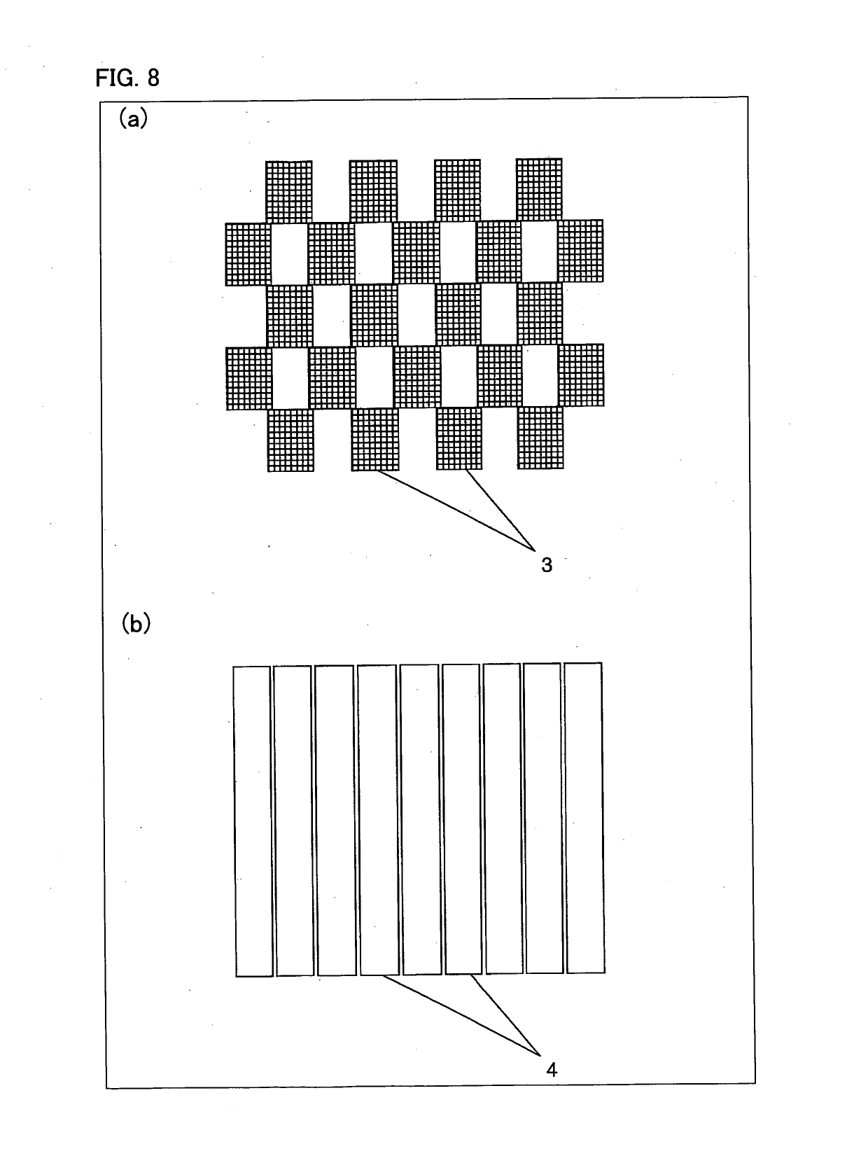

In an eighth embodiment of the invention, again a staggered barrier is used, but this time the lenses are not staggered, but are striped as in the preferred embodiment, except that in order to cover all of the barrier slits, the pitch of the lenses must be halved. This has the result that, if the ratio of the widths of the lens to the barrier is greater than 1, then the lenses merge into each other. This embodiment, therefore, is more suited to cases where the lens to barrier ratio is less than 1, as shown in Portions (a) and (b) of FIG. 8.

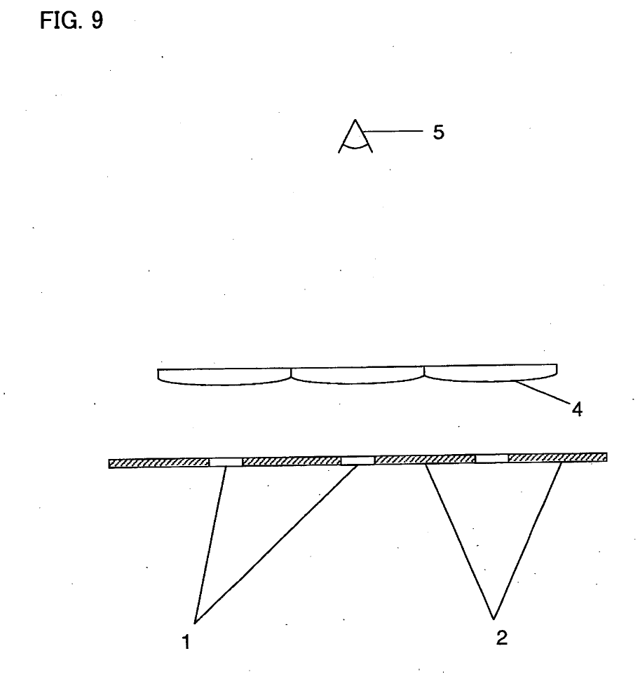

In a ninth embodiment of the invention, which applies to all of those above, there is no barrier between the lenses, as shown in FIG. 9. In cases where privacy is less important than light throughput, this may be the best possible design.

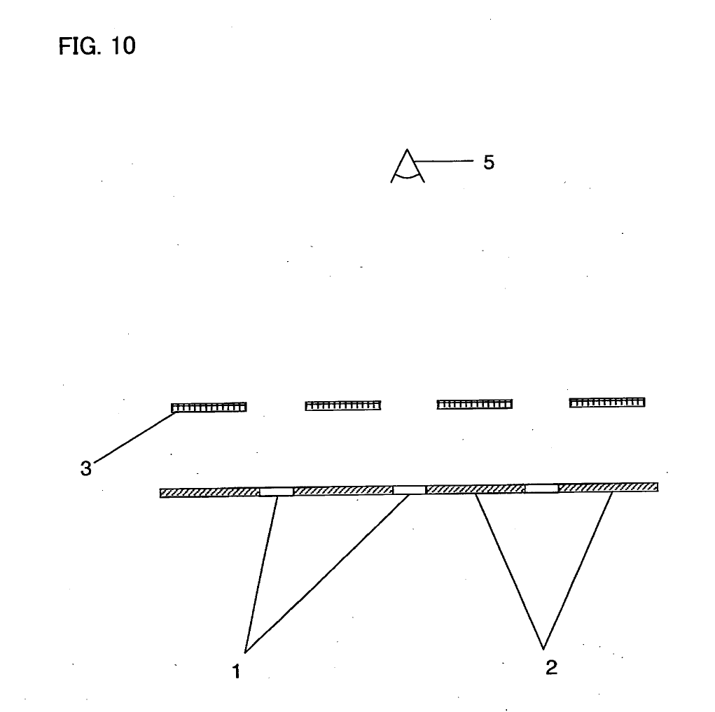

In a tenth embodiment of the invention, which again applies to embodiments 1-8, there are no lenses covering the barrier slits, as shown in FIG. 10. Such an arrangement will have inferior brightness when compared with a system that does have lenses. However, it may be necessary either for cost reasons, or for polarisation preservation in the case of an LCD, to use a system without lenses.

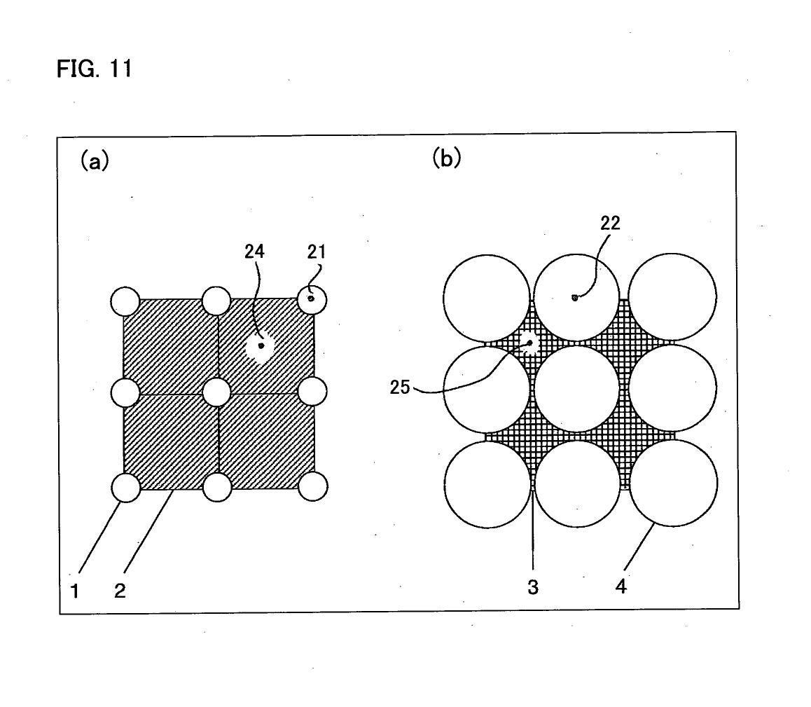

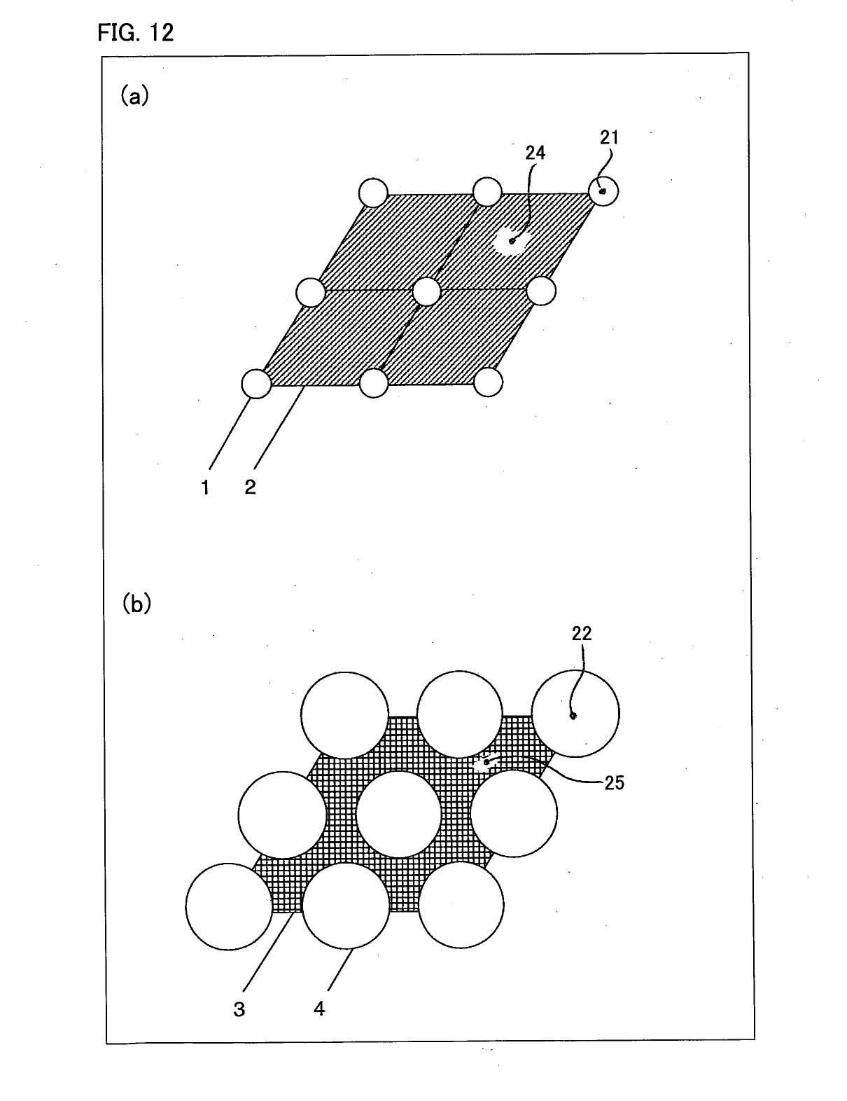

In the previous embodiments of the invention, as a result of the geometry of the pixel layout, cylindrical lenses and striped barrier, the resulting privacy is in a single plane. For example, the technology might typically be applied to a laptop computer screen so that viewers sitting in seats either side of the legitimate viewer are prevented from seeing the private image. However, a viewer standing up behind the legitimate user would be able to see the image quite clearly. In some cases, therefore, it is desirable to be able to engineer privacy in all planes. In an eleventh embodiment of the invention, this is achieved by using spherical lenses instead of cylindrical ones, and the pixel shapes are very different. FIG. 11 shows a possible layout for pixel types 1 and 2 that uses a square lattice, and the corresponding lens and barrier arrangement (3+4). FIG. 12 shows a variant of this design in which a hexagonal lattice is used.

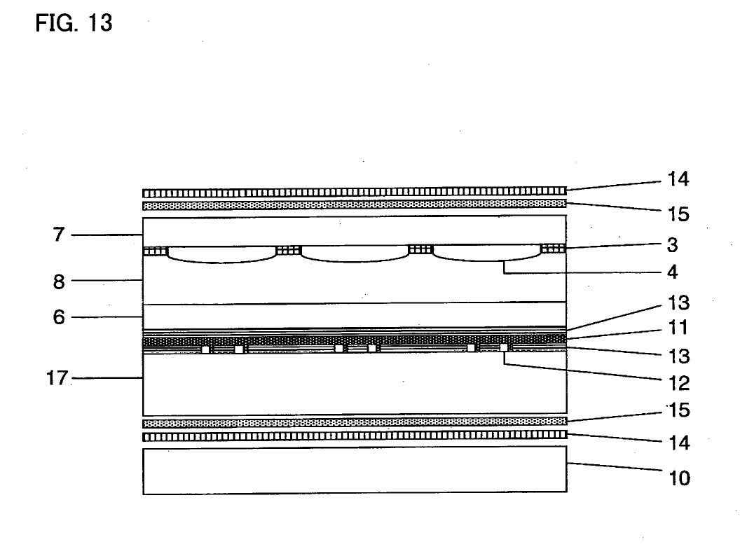

In a twelfth embodiment of the invention, the type of display used is a transmissive LCD. The source of light is a backlight (10) which is placed on the opposite side of the display to the lens plus barrier arrangement. In this case, the image forming layer is a thin layer of liquid crystal (11), which is addressed by TFTs (12) connected to transparent indium tin oxide (ITO) electrodes (13). In order to form an image, the liquid crystal layer must be sandwiched by a pair of polarisers (14) and the image quality is often improved by the use of compensation films (15) either side of the liquid crystal layer and inside the polarisers. In this embodiment, the lens and barrier arrangement (3+4) can be between the polarisers so that the order of the elements from backlight to viewer is: polariser (14), compensation layer (15), liquid crystal layer (11), lens and barrier arrangement (3+4), compensation layer (15), polariser (14). This arrangement is shown in FIG. 13.

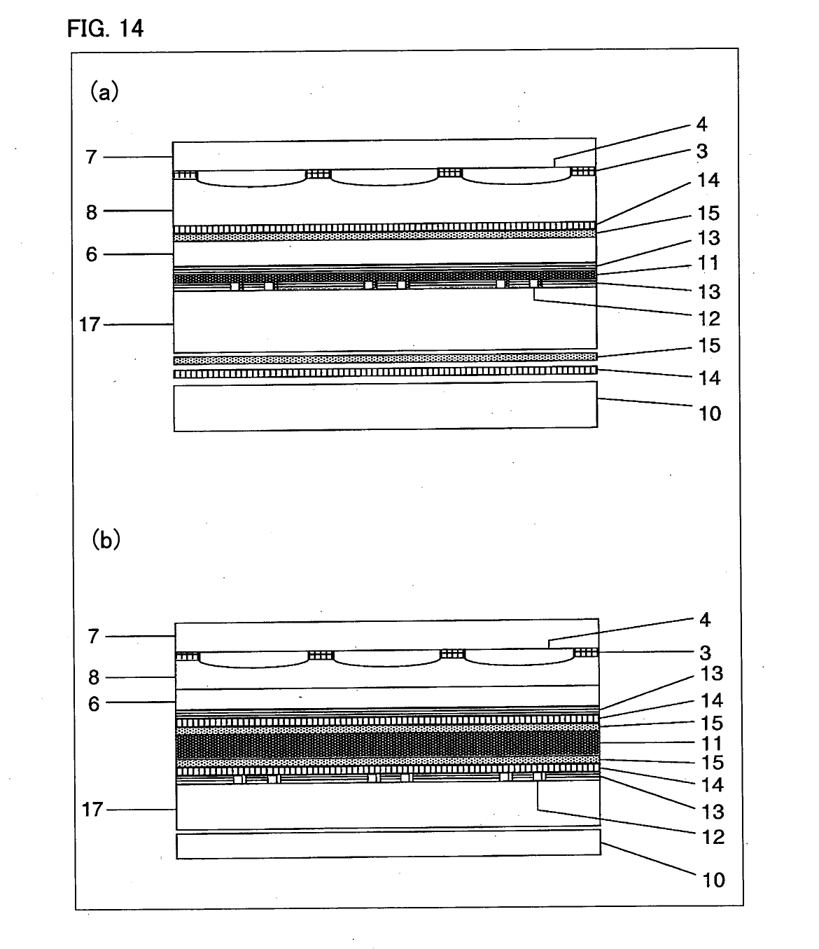

In a thirteenth embodiment of the invention, the type of display used is also a transmissive LCD, as in the previous embodiment. However, in this case, the lens and barrier arrangement (3+4) can be situated outside of the polariser pair (14) as shown in Portions (a) and (b) of FIG. 14. The order of the elements from backlight to viewer is now: polariser (14), compensation layer (15), liquid crystal layer (11), compensation layer (15), polariser (14), lens and barrier arrangement (3+4). The polarisers and compensation layers may be of the type that are laminated onto the glass substrates sandwiching the liquid crystal layer, as depicted in Portion (a) of FIG. 14. Alternatively, they may be of the in-cell variety so that they are between the glass substrates and the liquid crystal layer (Portion (b) of FIG. 14). Alternatively there may be a combination of the two types, for example, in-cell compensation layers but laminatable polarisers.

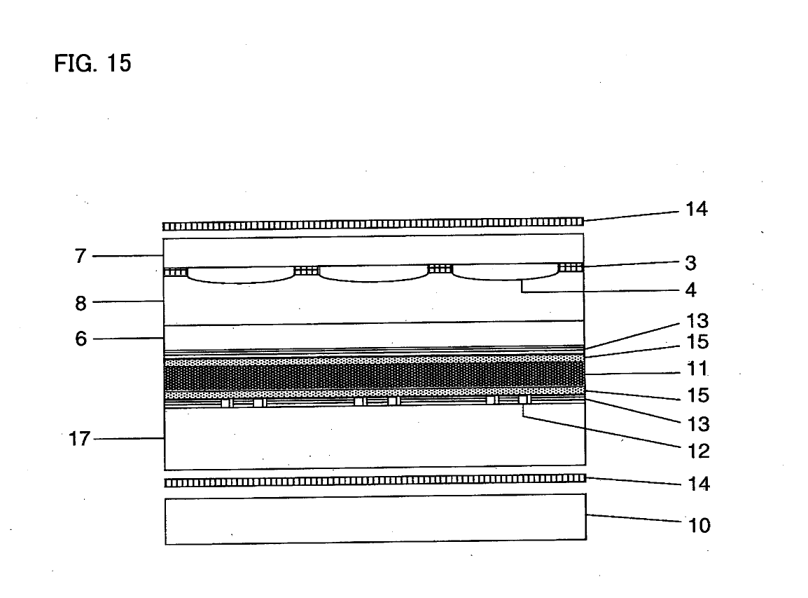

In a fourteenth embodiment of the invention, the type of display used is again a transmissive LCD as in the previous embodiment. In this case, the polarisers are located either side of the lens and barrier arrangement, but the compensation layers are both on one side of the lens and barrier arrangement, as shown in FIG. 15. Again, the compensation layers (15) can be positioned outside the glass substrates or inside adjacent the liquid crystal layer (11).

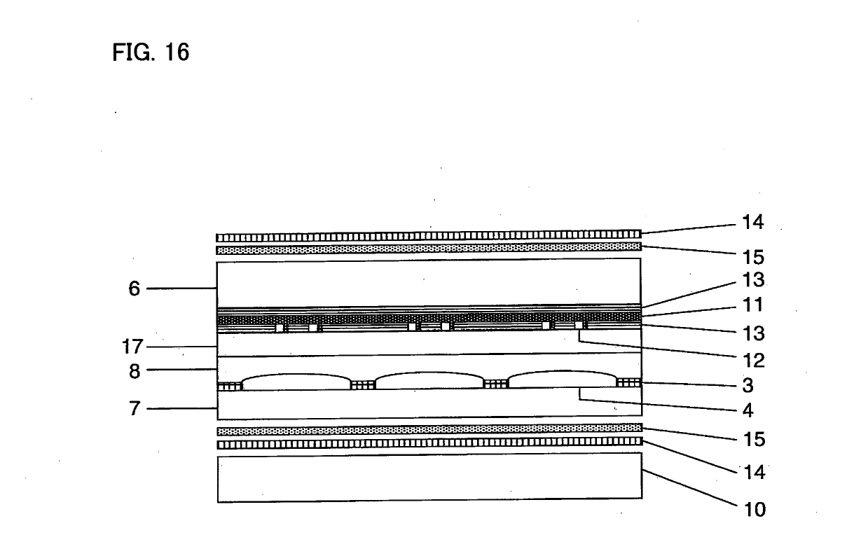

In a fifteenth embodiment of the invention, the type of display used is again a transmissive LCD. However, as FIG. 16 shows, the lens plus barrier arrangement is placed between the backlight and the LCD.

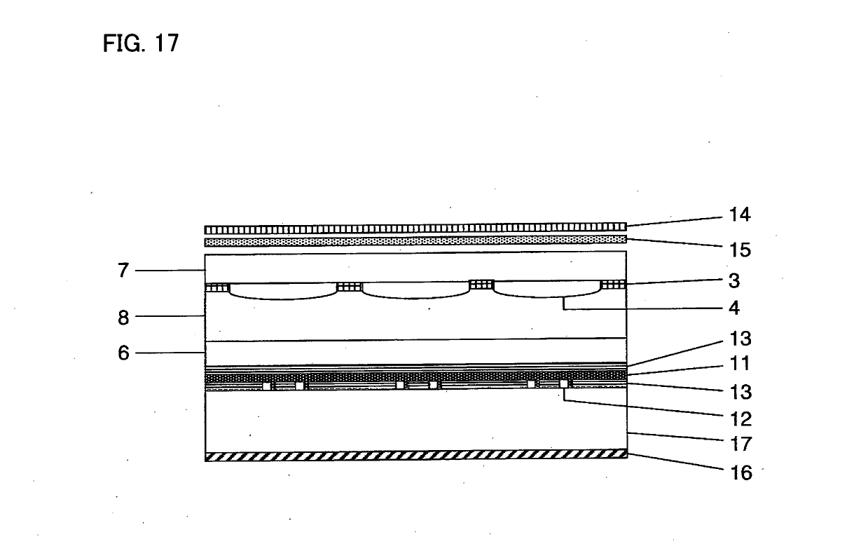

In a sixteenth embodiment of the invention, the type of display used is a reflective LCD, as shown in FIG. 17. The source of light here is the ambient light, which passes through the front polariser (14), then the optional compensation layer (15), then the lens plus barrier arrangement (3+4) and the liquid crystal layer (11), before being reflected from a reflector (16), and then passing again through the liquid crystal layer, lens plus barrier arrangement, and polariser once more. In this embodiment, the reflector is positioned below the lower substrate (17).

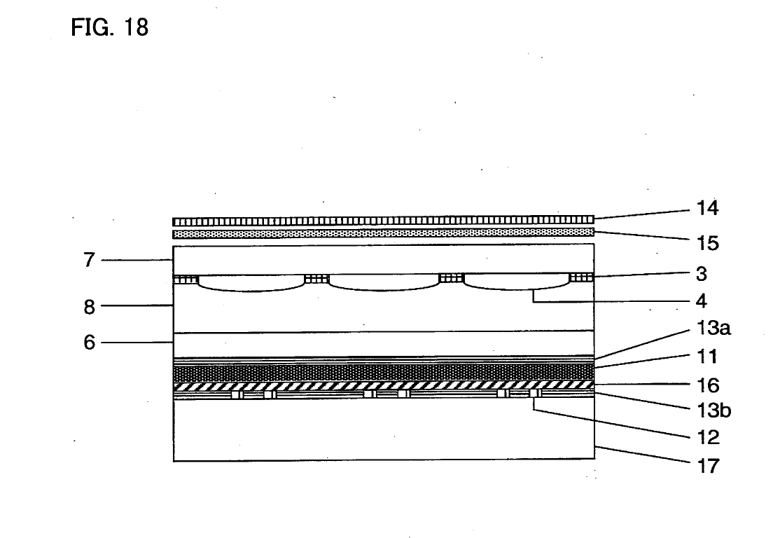

In a seventeenth embodiment of the invention, the type of display used is a reflective LCD, as in the previous embodiment, except that the reflector is positioned between the lower electrode (13b) and the LC layer (11), instead of underneath the lower substrate (17), as shown in FIG. 18.

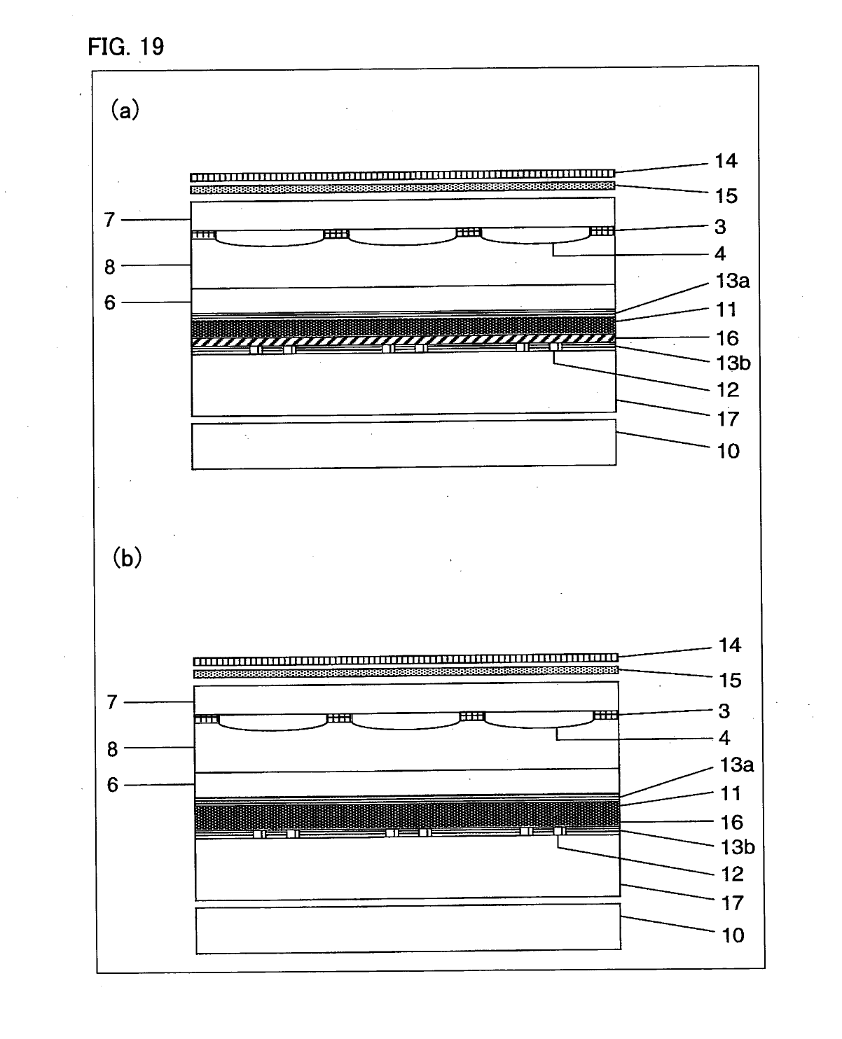

In an eighteenth embodiment of the invention, the type of display used is a transflective LCD, in which each pixel of the display has both transmissive and reflective portions. Ideally, the division of each pixel into these two regions occurs along the axis of the lenses so that the regions alternate along the lens axis. Portion (a) of FIG. 19 shows a cross-section of the device within a reflective portion, and Portion (b) of FIG. 19 shows a cross-section within a transmissive portion.

In a nineteenth embodiment of the invention, the type of display used is any other type of reflective display that does not rely on polarisation optics. For example, FIG. 19 shows an electrophoretic display, where element 18 is the electrophoretic layer.

Any type of emissive display may be used, such as CRT, LED, OLED, PDP, FED, SED.

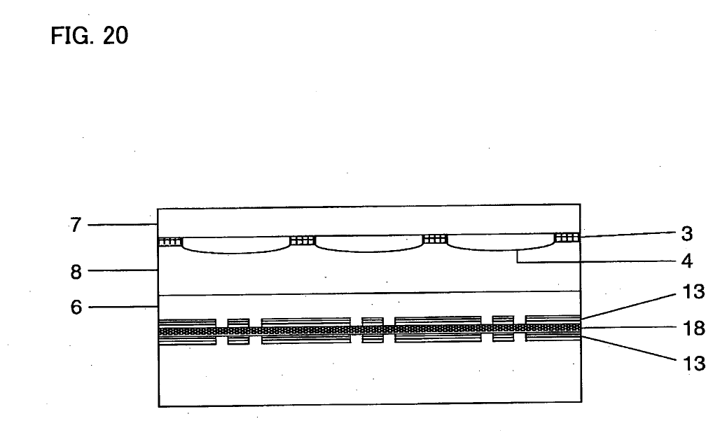

In a twentieth embodiment of the invention, the type of display used is anything which only operates in either reverse or forward bias, for example an LED or OLED display. The example of an OLED display (FIG. 20) will be used here to illustrate the concept of this embodiment of the invention. This embodiment also only applies to cases where a secondary image is not required: all that is needed is to change the viewing angle of a single image. In this case, when the display is used in “private” mode, pixel set 2 is simply switched off, i.e. does not need to be addressed with a separate set of data that differs from the set of data applied to pixel set 1. In the case of an OLED display which is operated in forward bias, it is possible to address both pixels 1 and 2 with the same TFT (or combination of TFTs as needed to provide the necessary current for the OLED emission).

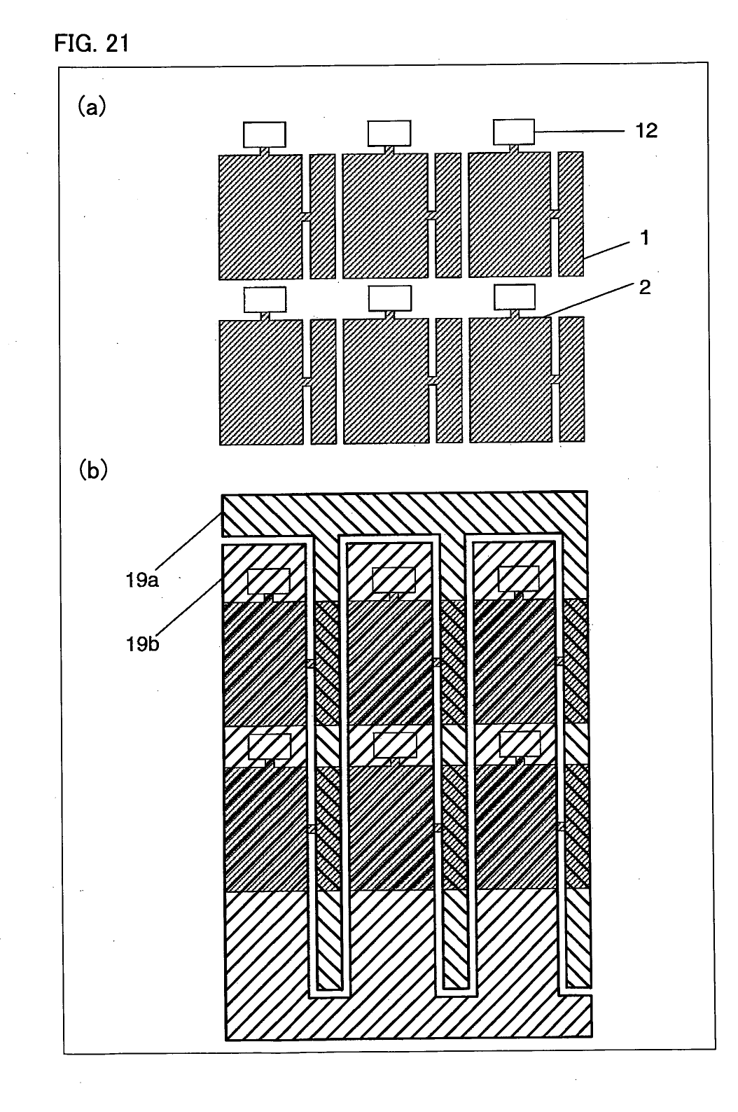

Portion (a) of FIG. 21 shows a possible pixel layout for the transparent anode/TFT substrate. Six identical pixels are shown, each of which comprises of a TFT (or cluster of TFTs) (12) which is connected to an area of transparent conductor that corresponds to pixel set 2, which is in turn connected to a further area of transparent conductor that corresponds to pixel set 1. In every pixel, therefore, the voltages on the parts of the transparent anode corresponding to pixel sets 1 and 2 are identical. In general this voltage will be in a range 0 to V₁ (V₁<0).

Portion (b) of FIG. 21 shows how the (normally reflective) cathode 19 is aligned relative to the transparent pixel electrodes 13. In an ordinary OLED display, the cathode would not be patterned. However, in this embodiment, it is divided into two regions 19a and 19b which are aligned with the transparent anodes for pixel sets 1 and 2, respectively. In order to illuminate both sets of pixels, the voltage of electrodes 19a and 19b should be set to zero. In order to switch off pixel set 2, all that is needed is to lower the voltage on electrode 19b to a negative value V₂<V₁, so that pixel set 2 is no longer in forward bias and no light will be emitted from these pixels. By changing from a situation where all pixels are illuminated to one in which only pixel set 1 is illuminated, the viewing angle of the display will be changed from wide to narrow.

The advantage of this system is that, because the same data is applied to pixel set 1 and 2, only 1 TFT (or the same number of TFTs that would be needed to control a single pixel in a normal display) is needed to control the pair of pixels 1 and 2. By patterning the opposite electrode to coincide with pixel areas 1 and 2 and controlling these independently, it is then possible to choose whether to display the TFT data on pixel set 1, 2, both or neither. This works for an LED or OLED display because it requires forward bias, but could not be used (for example) in a nematic LCD because this responds to both positive and negative voltage. However, it may be of use in bistable or polar LCDs (such as ferroelectric or flexoelectrics) which depend on the sign of the applied voltage for their addressing.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A display having private and public viewing modes, comprising a display device and a parallax optic, the parallax optic comprising an array of parallax elements, each of which cooperates with a respective set of pixels of the display device comprising at least one first pixel, which is aligned with the parallax element such that a straight line passing through a centre of the at least one first pixel and through a centre of the parallax element extends into a first viewing region, and at least one second pixel such that the parallax elements restrict viewing of the first pixels to the first viewing region and permit viewing of the second pixels in a second viewing region, the display device being arranged to display a private image in the private viewing mode by means of only the first pixels and to display a first non-private image in the public viewing mode by means of at least the second pixels.

2. A display as claimed in claim 1, in which at least one of the sets of pixels is disposed at or adjacent middle of a surface of the display device in which the pixels are disposed and the straight line intersects the surface substantially perpendicularly.

3. A display as claimed in claim 2, in which the surface is substantially planar.

4. A display as claimed in claim 1, in which each parallax element is a one-dimensional parallax element, the at least one first pixel comprises a line of first pixels have a centre line which is aligned with the centre line of the parallax element such that at least part of a plane containing the centre lines of the parallax element and the line of first pixels extends into the first viewing region, and the at least one second pixel comprises first and second lines of second pixels, parallel to and on opposite sides of the line of first pixels.

5. A display as claimed in claim 4, in which, in each pair of adjacent sets, the first line of second pixels of one of the sets comprises the second line of second pixels of the other of the sets and is aligned with a line midway between the centre lines of the associated parallax elements.

6. A display as claimed in claim 1, in which the display device is arranged to display a second non-private image in the private viewing mode by means of the second pixels.

7. A display as claimed in claim 6, in which the second non-private image is same as the first non-private image.

8. A display as claimed in claim 1, in which the display device is arranged to display the first non-private image in the public viewing mode by means of the first and second pixels.

9. A display as claimed in claim 8, in which the first and second viewing regions partially overlap and the first and second pixels are arranged, in the public viewing mode, to display different image pixels of the first non-private image.

10. A display as claimed in claim 1, in which the second viewing region comprises a plurality of sub-regions.

11. A display as claimed in claim 10, in which the sub-regions are substantially non-overlapping.

12. A display as claimed in claim 10, in which the first viewing region is disposed between first and second ones of the sub-regions.

13. A display as claimed in claim 1, in which the array is a regular array.

14. A display as claimed in claim 1, in which the parallax optic comprises a lens array and each parallax element comprises a lens of the array.

15. A display as claimed in claim 1, in which the parallax optic comprises a parallax barrier and each parallax element comprises an aperture.

16. A display as claimed in claim 15, in which the parallax optic comprises a respective lens at each aperture of the barrier.

17. A display having private and public viewing modes, comprising a display device and a parallax optic, the parallax optic comprising an array of lenses separated from each other by opaque regions, each of the lenses cooperating with a respective set of pixels of the display device comprising at least one first pixel and at least one second pixel such that the lenses restrict viewing of the first pixels to a first viewing region and permit viewing of the second pixels in a second viewing region, the display device being arranged to display a private image in the private viewing mode by means of only the first pixels and to display a first non-private image in the public viewing mode by means of at least the second pixels.

18. A display as claimed in claim 1, in which the parallax elements have a pitch which differs from a pitch of the sets of pixels so as to provide view point correction.

19. A display as claimed in claim 1, in which the first pixels are of a different size from the second pixels.

20. A display having private and public viewing modes, comprising a display device and a parallax optic, the parallax optic comprising an array of parallax elements, each of which cooperates with a respective set of pixels of the display device comprising at least one first pixel and at least one second pixel such that the parallax the parallax elements restrict viewing of the first pixels to a first viewing region and permit viewing of the second pixels in a second viewing region, the first pixels being of a different size from the second pixels, the display device being arranged to display a private image in the private viewing mode by means of only the first pixels and to display a first non-private image in the public viewing mode by means of at least the second pixels.

21. A display as claimed in claim 19, in which each of the first pixels is smaller than each of the second pixels.

22. A display as claimed in claim 21, in which each of the first pixels is narrower than each of the second pixels.

23. A display as claimed in claim 1, in which each of the sets comprises at least one further pixel.

24. A display as claimed in claim 1, in which the display device is arranged to modulate light passing therethrough.

25. A display as claimed in claim 24, in which the display device is a liquid crystal device.

26. A display as claimed in claim 1, in which the display device is a light-emissive device.

27. A display as claimed in claim 26, in which the display device is an emitting diode device comprising a plurality of pixel-defining electrodes facing first and second patterned electrodes defining the first and second pixels, respectively.

28. A display as claimed in claim 1, in which the parallax optic is disposed between the display device and the first and second viewing regions.

29. A display as claimed in claim 24, in which the display device is at least partially transmissive and is disposed between the parallax optic and the first and second viewing regions.
